(19) United States
(12) Patent Application Publication
(10) Pub. No.: US 2008/0244352 A1
(43) Pub. Date: Oct. 2, 2008

(54) APPARATUS AND METHOD FOR TRANSMITTING DATA AND APPARATUS AND METHOD FOR RECEIVING DATA

(75) Inventors: Chang-Yeul KWON, Yongin-si (KR); Dong-Hwi Roh, Seoul (KR); Seong-Soo Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/056,717

(22) Filed: Mar. 27, 2008

Related U.S. Application Data
(60) Provisional application No. 60/907,274, filed on Mar. 27, 2007.

(30) Foreign Application Priority Data
Mar. 11, 2008 (KR) 10-2008-0022581

(51) Int. Cl. H04L 1/08; G06F 11/14; G06F 11/07

(52) U.S. Cl. 714/748; 714/799; 714/E11.113; 714/E11.024

(57) ABSTRACT

Provided are an apparatus and method for transmitting data and an apparatus and method for receiving data, in which the transmission of uncompressed data over a wireless network can be performed by retransmitting an erroneous bit or a group of erroneous bits, if any, of each sub-packet including a number of bits or a number of groups of bits having different significance levels. The apparatus for transmitting data includes an error detection module which determines whether each of a plurality of portions of a transmitted packet having different significance levels is erroneous based on a received response packet; a data-packet generation module which generates a retransmission packet including one or more erroneous portions of the transmitted packet according to the results of the determination performed by the error detection module; and a communication module which transmits the retransmission packet through a communication channel.

### CROSS-REFERENCE TO RELATED APPLICATION

This application claims priority from Korean Patent Application No. 10-2008-0022581, filed on Mar. 11, 2008 in the Korean Intellectual Property Office, and U.S. Patent Provisional Application No. 60/907,274, filed on Mar. 27, 2007 in United States Patent Trademark Office, the disclosures of which are incorporated herein by reference in their entirety.

### BACKGROUND OF THE INVENTION

1. Field of the Invention

Apparatuses and methods consistent with the present invention relates to transmitting and receiving data, and more particularly, to transmitting and receiving data, in which the transmission of uncompressed data over a wireless network can be performed by retransmitting an erroneous bit or a group of erroneous bits, if any, of each sub-packet including a number of bits or a number of groups of bits having different significance levels.

2. Description of the Related Art

As networks become increasingly wireless and the demand for large multimedia data transmission increases, there is a need for a more effective transmission method in a wireless network environment. In particular, the need for various home devices to wirelessly transmit high-quality videos, such as digital versatile disk (DVD) images or high definition television (HDTV) images, is growing.

Eight bits of one-byte data may differ from one another in terms of significance in the restoration of image signals or sound signals.

If data transmission is performed by applying the same data retransmission protocol to the most significant bits (MSBs) and the lowest-order bits (LSBs) alike, the quality of data may deteriorate. Therefore, a data transmission/reception scheme, in which different data retransmission protocols are respectively applied to MSBs and LSBs, is needed.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Accordingly, aspects of the present invention provide an apparatus and method for transmitting data and an apparatus and method for receiving data, in which the transmission of uncompressed data over a wireless network can be performed by retransmitting an erroneous bit or a group of erroneous bits, if any, of each sub-packet including a number of bits or a number of groups of bits having different significance levels.

According to an aspect of the present invention, there is provided an apparatus for transmitting data, the apparatus including: an error detection module which determines whether each of a plurality of portions of a transmitted packet having different significance levels is erroneous based on a received response packet; a data-packet generation module which generates a retransmission packet including one or more erroneous portions of the transmitted packet according to the results of the determination performed by the error detection module; and a communication module which transmits the retransmission packet through a communication channel.

According to another aspect of the present invention, there is provided an apparatus for receiving data, the apparatus including: a packet inspection module which inspects each of a plurality of portions of a received packet having different significance levels for errors; a packet generation module which generates a response packet including the results of the inspection performed by the packet inspection module; and a communication module which transmits the response packet.

According to another aspect of the present invention, there is provided a method of transmitting data, the method including: determining whether each of a plurality of portions of a transmitted packet having different significance levels is erroneous based on a received response packet; generating a retransmission packet including one or more erroneous portions of the transmitted packet according to the results of the determining; and transmitting the retransmission packet through a communication channel.

According to another aspect of the present invention, there is provided a method of receiving data, the method including: inspecting each of a plurality of portions of a received packet having different significance levels for errors; generating a response packet including the results of the inspecting; and transmitting the response packet.

### BRIEF DESCRIPTION OF THE DRAWINGS

The above and other aspects and features of the present invention will become more apparent by describing in detail exemplary embodiments thereof with reference to the attached drawings, in which:

FIG. 1 illustrates a diagram for comparing frequency bands of the IEEE 802.11 series of standards and mmWave standard;

FIG. 2 illustrates a diagram of a pixel including a plurality of bits having different bit levels;

FIG. 3 illustrates a diagram for explaining a related art ECC method;

FIG. 4 illustrates a diagram for explaining an ECC method according to an exemplary embodiment of the present invention;

FIG. 5 illustrates a schematic diagram of a wireless network system according to an exemplary embodiment of the present invention;

FIG. 6 illustrates a diagram for explaining how to divide a packet into a plurality of sub-packets according to an exemplary embodiment of the present invention;

FIG. 7 illustrates a diagram of a data packet according to an exemplary embodiment of the present invention;

FIG. 8 illustrates a diagram of a response packet according to an exemplary embodiment of the present invention;

FIG. 9 illustrates a block diagram of an apparatus for transmitting data according to an exemplary embodiment of the present invention;

FIG. 10 illustrates a block diagram of an apparatus for receiving data according to an exemplary embodiment of the present invention; and

FIG. 11 illustrates a flowchart of the transmission of a data packet and a response packet according to an exemplary embodiment of the present invention.

### DETAILED DESCRIPTION OF EXEMPLARY EMBODIMENTS OF THE INVENTION

The various aspects and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the present invention to those skilled in the art, and the present invention is defined by the appended claims. Like reference numerals refer to like elements throughout the specification.

The present invention will hereinafter be described in detail with reference to the accompanying drawings.

The term “module”, as used herein, includes, but is not limited to, a software or hardware component, such as a Field Programmable Gate-Array (FPGA) or Application-Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

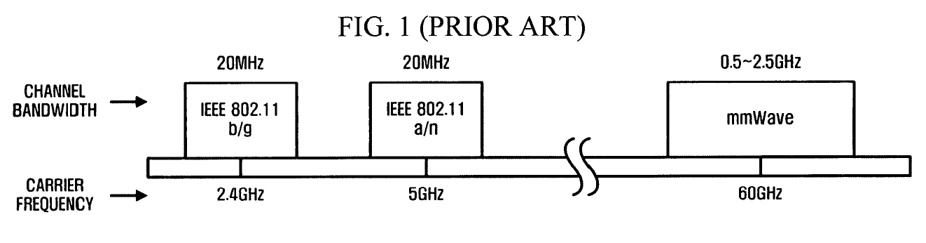

FIG. 1 illustrates a diagram for comparing frequency bands of the IEEE 802.11 series of standards and millimeter wave (mmWave). Referring to FIG. 1, the IEEE 802.11b and IEEE 802.11g standards use a carrier frequency of 2.4 GHz and have a channel bandwidth of approximately 20 MHz. In addition, the IEEE 802.11a and IEEE 802.11n standards use a carrier frequency of 5 about GHz and have a channel bandwidth of approximately 20 MHz. On the other hand, mmWave uses a carrier frequency of 60 GHz and has a channel bandwidth of approximately 0.5-2.5 GHz. Thus, mmWave has a far greater carrier frequency and channel bandwidth than the related art IEEE 802.11 series of standards. When a high-frequency signal (i.e., a millimeter wave) having a millimeter wavelength is used, a very high transmission rate of several Gbps can be achieved. Since the size of an antenna can also be reduced to less than about 1.5 mm, a single chip which includes the antenna can be implemented. Further, interference between devices can be reduced due to a very high attenuation ratio of the high-frequency signal in the air.

A method of transmitting uncompressed audio/video (A/V) data between wireless devices using a high bandwidth of a millimeter wave has been studied. Compressed A/V data is generated after lossy compression processes such as motion compensation, discrete cosine transform (DCT), quantization, and variable length coding (VLC) processes. In so doing, components of compressed A/V data that are not likely to be perceptive to the human visual and auditory senses are removed. On the other hand, uncompressed A/V data includes digital values indicating pixel components (for example, red (R), green (G) and blue (B) components). Therefore, wireless devices can transmit uncompressed data to each other, thereby providing users with high-quality A/V content.

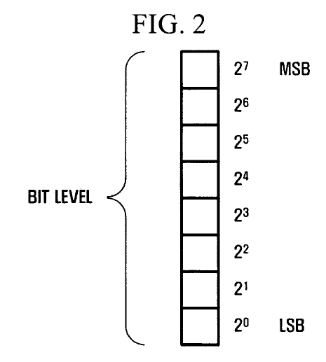

Bits of compressed data are not different from one another in terms of significance, whereas bits of uncompressed are different from one another. For example, referring to FIG. 2, each pixel of an eight-bit image is represented by eight bits. The highest-order bit (or a highest-level bit) of the eight bits is referred to as the most significant bit (MSB), and the lowest-order bit (or a lowest-level bit) of the eight bits is referred to as the least significant bit (LSB). That is, eight bits of one-byte data may differ from one another in terms of significance in the restoration of image signals or sound signals.

Errors in significant bits are detected more easily than errors in less significant bits. Thus, in order to prevent the occurrence of errors during data transmission, it is more important to protect significant bit data than to protect less significant bit data. However, in related art data transmission schemes such as IEEE 802.11, an error correction code (ECC) method in which the same coding rate is applied to all bits of data to be transmitted is used.

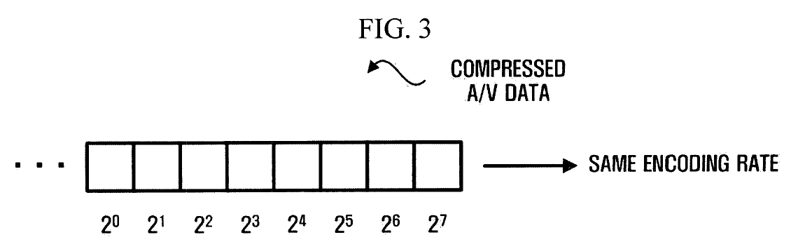

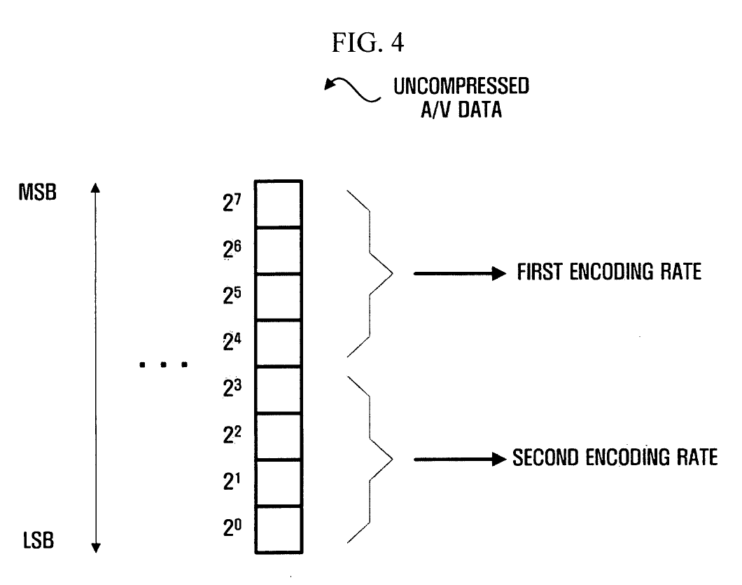

FIG. 3 illustrates a diagram for explaining a related art ECC method, and FIG. 4 illustrates a diagram for explaining an ECC method according to an exemplary embodiment of the present invention.

Compressed A/V data is obtained by performing various processes for improving compression rate such as quantization and entropy coding. Thus, referring to FIG. 3, a plurality of bits of each pixel of compressed A/V data are not different from one another in terms of significance. Thus, a plurality of bits of each pixel of compressed A/V data may be error-correction-coded using the same encoding rate. Alternatively, a plurality of bits of each pixel of compressed A/V data may be error-correction-coded at different rates not because they have different significance levels but because they are influenced by different external conditions (such as different communication environments).

On the other hand, a plurality of bits of each pixel of uncompressed A/V data have different significance levels, as illustrated in FIG. 2. Thus, referring to FIG. 4, a plurality of bits of each pixel of uncompressed A/V data have different significance levels may be classified into a number of bit groups according to their bit levels, and then ECC may be performed by applying different encoding rates to the bit groups.

More specifically, if a plurality of bits of each pixel of uncompressed A/V data are all error-correction-coded at different levels, the amount of computation of a data transmission apparatus and a data reception apparatus may considerably increase. Thus, a plurality of bits of each pixel of uncompressed A/V data have different significance levels may be classified into a number of bit groups according to their bit levels, and then ECC may be performed by applying different encoding rates to the bit groups. A lower encoding rate may be applied to a group of bits having a high significance level than to a group of bits having a low significance level.

A data transmission apparatus may transmit a packet and then retransmit a packet later if the packet is determined to be erroneous. A data transmission apparatus may perform error correction coding on a packet by applying either the same encoding rate or different encoding rates to a plurality of bits in the packet in consideration of the data processing capability of the data transmission apparatus, the data processing capability of a data reception apparatus, and the properties of a network environment.

A data transmission apparatus may transmit a packet and may then transmit a retransmission packet including all the data in the packet. Alternatively, a data transmission apparatus may transmit a packet and may then transmit a retransmission packet including only an erroneous portion of the data in the packet. For this, a packet may be divided into a number of units. The units of a packet will hereinafter be referred to as sub-packets.

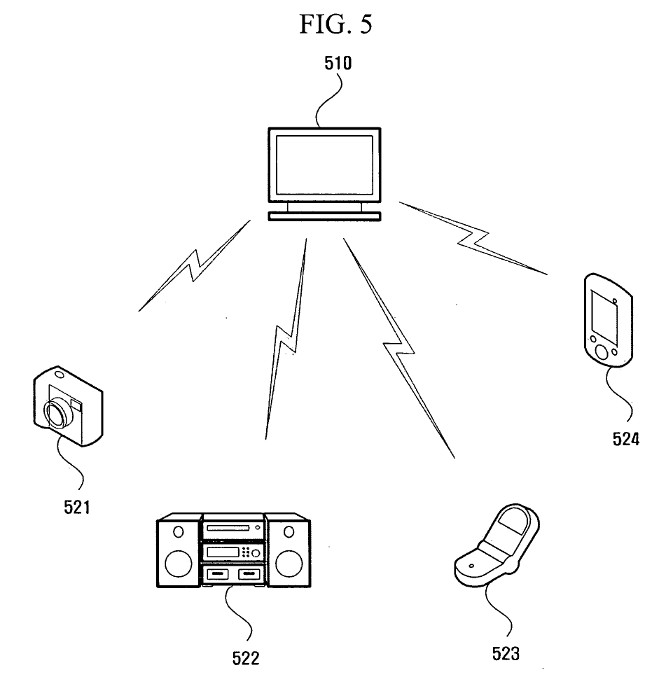

FIG. 5 illustrates a schematic diagram of a wireless network system according to an exemplary embodiment of the present invention. Referring to FIG. 5, the wireless network system includes a wireless network coordinator 510 and a plurality of stations 521 through 524.

The wireless network coordinator 510 coordinates bandwidth allocation for the stations 521 through 524 by transmitting a beacon frame. That is, the stations 521 through 524 may receive a beacon frame and wait for a band to be allocated thereto with reference to the received beacon frame. If a band is allocated, the stations 521 through 524 may be able to transmit data to other stations through the band.

A network may be configured using a super frame including one or more channel time blocks. A channel time block may be classified into either a reserved channel time block which is a reserved time period for allocating a band to a certain station in a network or an unreserved channel time block which is a time period for allocating a band to a station that wins the competition with other stations in a network. A channel time block is a time period during which data is transmitted between stations in a network and may correspond to a channel time allocation period and a contention access period.

In order to transmit data, stations may compete with one another during an unreserved channel time block. Alternatively, stations may transmit data during a reserved channel time block allocated thereto.

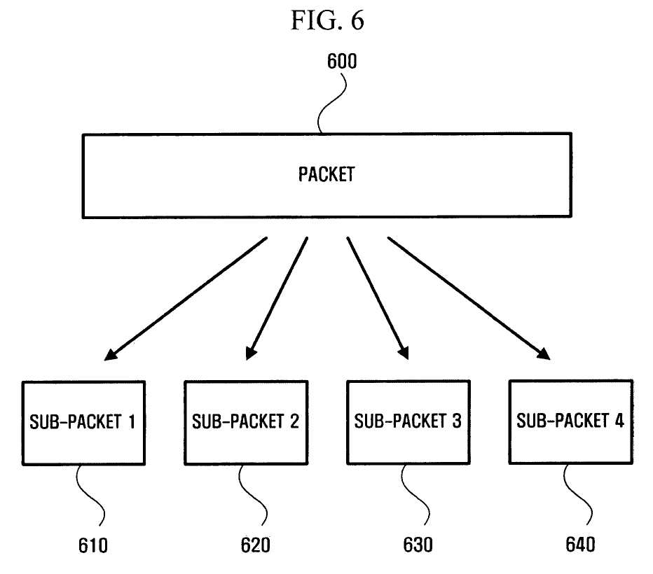

FIG. 6 illustrates a diagram for explaining how to divide a packet 600 into a plurality of sub-packets 610, 620, 630 and 640.

Communication methods are classified into a high-rate physical layer (HRP) method in which data is transmitted at high speed and a low-rate physical layer (LRP) method in which data is transmitted at low speed. The HRP method is generally used to transmit data at a rate of 3 Gbps or higher, and the LRP method is generally used to transmit data at a rate of 40 Mbps or lower.

The HRP method supports unidirectional data transmission. Examples of data that can be transmitted by the HRP method include isochronous data such as A/V data, asynchronous data, media access control (MAC) commands, antenna beam forming information and control data of upper layers for A/V devices.

The LRP method supports bidirectional data transmission. Examples of data that can be transmitted by the LRP method include isochronous data with low transmission rate such as audio data, asynchronous data with low transmission rate, MAC commands including beacon frames, response packets for HRP packets, antenna beam forming information, capability information and control data of upper layers for A/V devices.

Referring to FIG. 6, the packet 600 may be divided into the sub-packets 610, 620, 630 and 640. Then, the packet 600 may be transmitted in units of the sub-packets 610, 620, 630 and 640 by using the HRP method or the LRP method.

If an error is detected from a packet transmitted from an apparatus (hereinafter referred to as the data transmission apparatus) for transmitting data transmits a packet to an apparatus (hereinafter referred to as the data reception apparatus) for receiving data, the data reception apparatus may transmit a response packet indicating that the packet is erroneous to the data transmission apparatus. Then, the data transmission apparatus may retransmit the packet to the data reception apparatus.

More specifically, the data transmission apparatus may retransmit the whole packet or only erroneous portions of the packet to the data reception apparatus. For this, the data reception apparatus may need to inform the data transmission apparatus what portions of the packet are erroneous. Thus, the response packet transmitted by the data reception apparatus may specify what portions of the packet are erroneous.

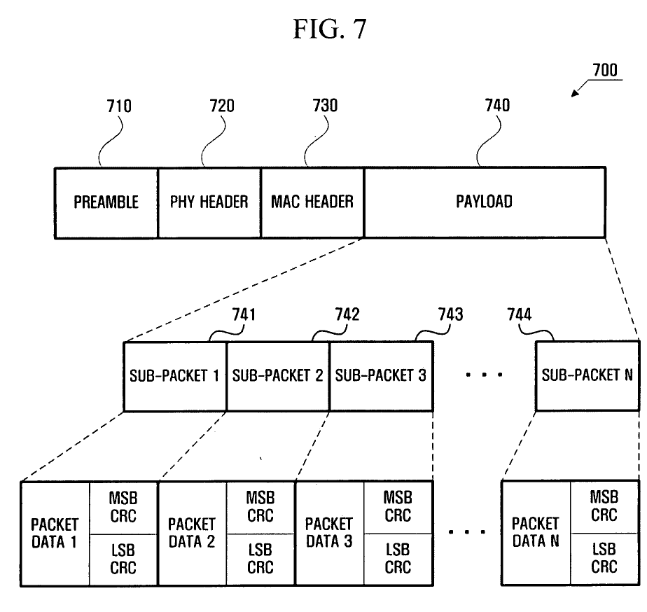

FIG. 7 illustrates a diagram of a data packet 700 according to an exemplary embodiment of the present invention. Referring to FIG. 7, the data packet 700 includes a preamble field 710, a physical (PHY) header field 720, an MAC header field 730, and a payload field 740.

The preamble field 710 includes a preamble, which is a signal for PHY layer synchronization and channel estimation. The preamble includes a plurality of short training signals. More specifically, the preamble includes a plurality of short training signals and a plurality of long training signals.

The PHY header field 720 may include information that can be used in the PHY layer such as beam tracking information for determining the transmission rate of the data packet 700, coding information of the data packet 700, sub-packet length information, or scrambler information.

The MAC header field 730 may include information that can be used in an MAC layer such as an identifier of a data transmission apparatus, an identifier of a data reception apparatus, an identifier of a network, an acknowledgement (ACK) policy or packet type information.

The payload field 740 includes one or more sub-packets: first through N-th packets 741 through 744. Each of the first through N-th sub-packets 741 through 744 includes packet data and cyclic redundancy check (CRC) codes. Packet data may be constituted by one or more portions having different significance levels. Thus, each of the first through N-th sub-packets 741 through 744 may include packet data and one or more CRC codes for respective corresponding portions of the packet data. When packet data is constituted by a number of portions having different significance levels, each of the portions of the packet data may include a bit or a group of bits. That is, each of the first through N-th sub-packets 741 through 744 may include one or more bits. Packet data may be divided into a number of portions having different significance levels and different sizes. Alternatively, packet data may be divided into a number of equal-sized portions having different significance levels, thereby facilitating the generation of a retransmission packet.

Packet data is illustrated in FIG. 7 as being constituted by an MSB portion and an LSB portion, but the present invention is not restricted to this. That is, packet data may be constituted by three or more portions.

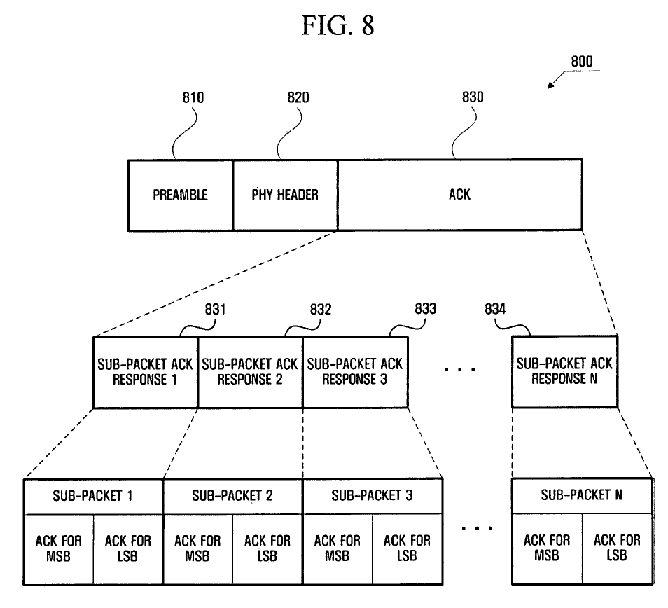

FIG. 8 illustrates a diagram of a response packet 800 according to an exemplary embodiment of the present invention. Referring to FIG. 8, the response packet 800 includes a preamble field 810, a PHY header field 820 and an ACK Field 830. The preamble field 810 and the PHY header field 820 are almost the same as the preamble field 710 and the PHY header field 720, respectively, of the data packet 700 and thus, detailed descriptions of the preamble field 810 and the PHY header field 820 will be skipped.

The ACK field 830 includes one or more sub-packet ACK response fields 831 through 834. Each of the sub-packet ACK response fields 831 through 834 may include error detection result data of each portion of a sub-packet. For example, each of the sub-packet ACK response fields 831 through 834 may be set to a value of 1 for erroneous sub-packet portions, and may be set to a value of 0 for non-erroneous sub-packet portions. Referring to FIG. 8, each of the sub-packet ACK response fields 831 through 834 includes error detection result data of each of the MSB and LSB portions of a sub-packet.

When the response packet 800 is received, a data transmission apparatus may generate a retransmission packet based on one or more erroneous sub-packet portions with reference to the sub-packet ACK response fields 831 through 834 of the response packet 800, and may transmit the retransmission packet.

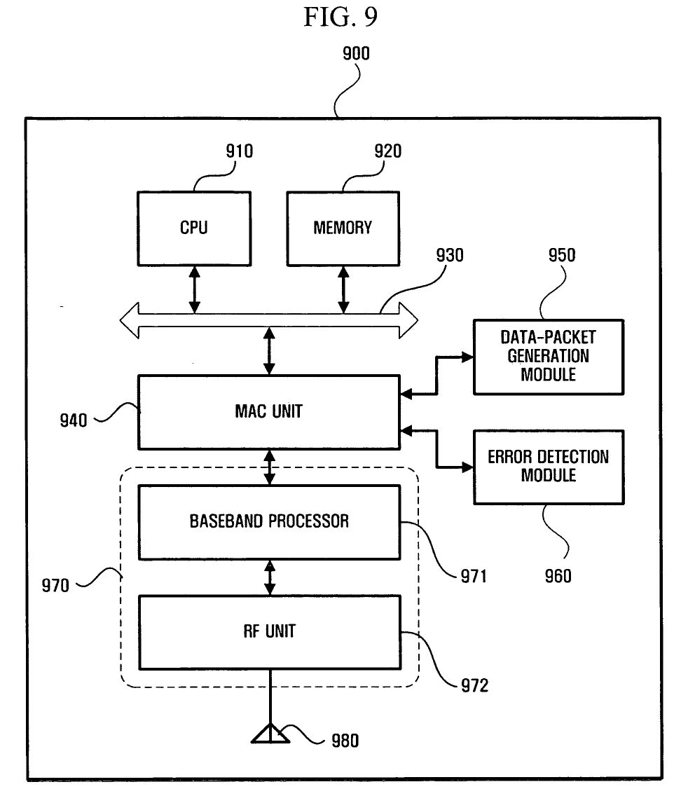

FIG. 9 illustrates a block diagram of a data transmission apparatus 900 according to an exemplary embodiment of the present invention. Referring to FIG. 9, the data transmission apparatus 900 includes a central processing unit (CPU) 910, a memory 920, a bus 930, an MAC unit 940, a data-packet generation module 950, an error detection module 960, a communication module 970 and an antenna 980.

The CPU 910 controls a number of elements of the data transmission apparatus 900, which are all connected to the bus 930. The CPU 910 may process received data (i.e., a received MAC service data unit (MSDU)) provided by the MAC unit 940. In addition, the CPU 910 generates data to be transmitted (i.e., an MSDU to be transmitted) and provides the generated data to the MAC unit 940.

The memory 920 stores data. The memory 920 may be a module such as a hard disc, a flash memory, a Compact Flash (CF) card, a Secure Digital (SD) card, a Smart Media (SM) card, a MultiMedia Card (MMC) card or a memory stick to/from which data can be input/output. The memory 920 may be included in the data transmission apparatus 900 or in an external apparatus. If the memory 920 is included in an external apparatus, the communication module 970 may access the memory 920 by communicating with the external apparatus.

The data-packet generation module 950 may generate an MAC protocol data unit (MPDU) by adding an MAC header to the data (i.e., an MSDU to be transmitted) provided by the CPU 410. The data-packet generation module 950 may generate a data packet including at least one sub-packet, which is divided into one or more portions having different significance levels. A data packet has already been described above with reference to FIGS. 6 and 7, and thus, a detailed description thereof will be skipped.

The data-packet generation module 950 may generate a retransmission packet including an erroneous portion of a transmitted packet, and particularly, an erroneous sub-packet of the transmitted packet.

More specifically, a number of packets having a uniform size may be included in a packet. Thus, the data-packet generation module 950 may insert a whole erroneous sub-packet of the transmitted packet into the retransmission packet including even if the erroneous sub-packet is only partially erroneous.

Alternatively, the data-packet generation module 950 may insert a sub-packet having an erroneous portion of the erroneous sub-packet and a null portion into the retransmission packet as a sub-packet of the retransmission packet if the erroneous sub-packet is only partially erroneous.

In addition, the data-packet generation module 950 may insert an erroneous sub-packet portion currently being detected into the retransmission packet along with a previously-detected erroneous sub-packet. For example, if sub-packet portion A of sub-packet 1 of the transmitted data and sub-packet portion B of sub-packet 2 of the transmitted data are erroneous and errors in sub-packet portion B are corrected, the data-packet generation module 950 may insert both sub-packet portions A and B into the retransmission packet as a sub-packet of the retransmission packet even if sub-packet portion B is no longer erroneous. In this case, it is assumed that each sub-packet is divided into a plurality of sub-packet portions sub-packet portions having the same size.

The data-packet generation module 950 may also include a CRC code for each sub-packet portion in a data packet or a retransmission packet. Thus, a data reception apparatus may determine whether each portion of a data packet is erroneous by performing CRC with reference to a number of CRC codes present in the data packet.

The error detection module 960 may determine whether each of a number of portions of a transmitted packet is erroneous with reference to a received response packet. Referring to FIG. 8, a response packet may include error detection result data for each portion of a transmitted packet. Thus, the error detection module 960 may determine whether each of a number of portions of a transmitted packet is erroneous with reference to error detection result data present in a received response packet.

The communication module 970 may convert a data packet or a retransmission packet generated by the data-packet generation module 950 into a wireless signal and may then transmit the wireless signal to a data reception apparatus through a communication channel. The communication module 970 may include a baseband processor 971 and a radio frequency (RF) unit 972. The communication module 970 may be connected to an antenna 980. The antenna 980 may transmit/receive low-frequency wireless signals with no directivity or high-frequency wireless signals with directivity. The RF unit 972 may establish a low-frequency communication channel having a channel bandwidth of about 2.4 GHz or about 5 GHz or a high-frequency communication channel having a channel bandwidth of about 60 GHz. Therefore, the communication module 970 may transmit a data packet or a retransmission packet using a channel bandwidth of about 0.5 GHz to about 2.5 GHz.

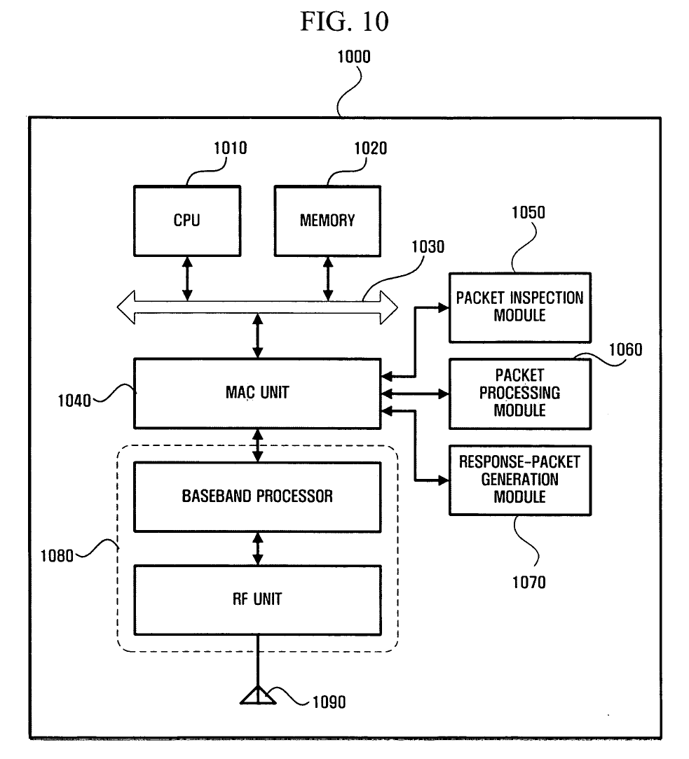

FIG. 10 illustrates a block diagram of a data reception apparatus 1000 according to an exemplary embodiment of the present invention. Referring to FIG. 10, the data reception apparatus 1000 includes a CPU 1010, a memory 102, a bus 1030, an MAC unit 1040, a packet inspection module 1050, a packet processing module 1060, a response-packet generation module 1070, a communication module 1080 and an antenna 1090. The CPU 1010, the memory 1020, the bus 1030, the MAC unit 1040, the communication module 1080 and the antenna 1090 have the same functions as their respective counterparts of the data transmission apparatus 900, and thus, detailed descriptions thereof will be skipped.

The packet inspection module 1050 may inspect each portion of a received packet for errors. More specifically, the received packet may include at least one sub-packet, which is divided into a plurality of sub-packet portions having different significance levels. Thus, the packet inspection module 1050 may determine whether each of the sub-packet portions is erroneous by performing CRC.

In general, packet inspection may be performed using parity code inspection, checksum inspection, CRC, microcom networking protocol (MNP), or V.42. CRC, unlike parity code inspection or checksum inspection, can detect more than one erroneous bit at the same time. In addition, CRC causes less overhead and is useful for handling random errors or a flood of errors. CRC is classified into CRC-16 and CRC-32 where the integer value of 16 or 32 indicates the number of bits used in computation for error detection.

A bit added to a packet as part of CRC is referred to as a frame check sequence. The term “frame check sequence” is often considered as referring to CRC. A frame check sequence may be added to a packet by the data transmission apparatus 900 in order to detect errors from the packet. When a packet to which a frame check sequence is added is received, the data reception apparatus 1000 compares the frame check sequence with a numerical value obtained by mathematical computation and thus determines whether the packet is erroneous based on the result of the comparison.

The packet inspection module 1050 may inspect each sub-packet portion of a sub-packet for errors by performing CRC, but the present invention is not restricted to this. That is, the packet inspection module 1050 may inspect each sub-packet portion of a sub-packet for errors by using parity code inspection, checksum inspection, MNP or V.42.

The packet processing module 1060 may remove one or more erroneous sub-packet portions of a sub-packet and store other non-erroneous sub-packet portions of the sub-packet in the memory 1020. The packet processing module 1060 may combine a portion of a received retransmission packet with a sub-packet portion present in the memory 1020, and may thus configure a whole packet.

The response-packet generation module 1070 may generate a response packet including the results of the inspection performed by the packet inspection module 1050. For example, the response-packet generation module 1070 may generate a response packet by setting a value of 0 for erroneous sub-packet portions and setting a value of 1 for non-erroneous sub-packet portions.

The communication module 1080 transmits the response packet generated by the response-packet generation module 1070 to the data transmission apparatus 900.

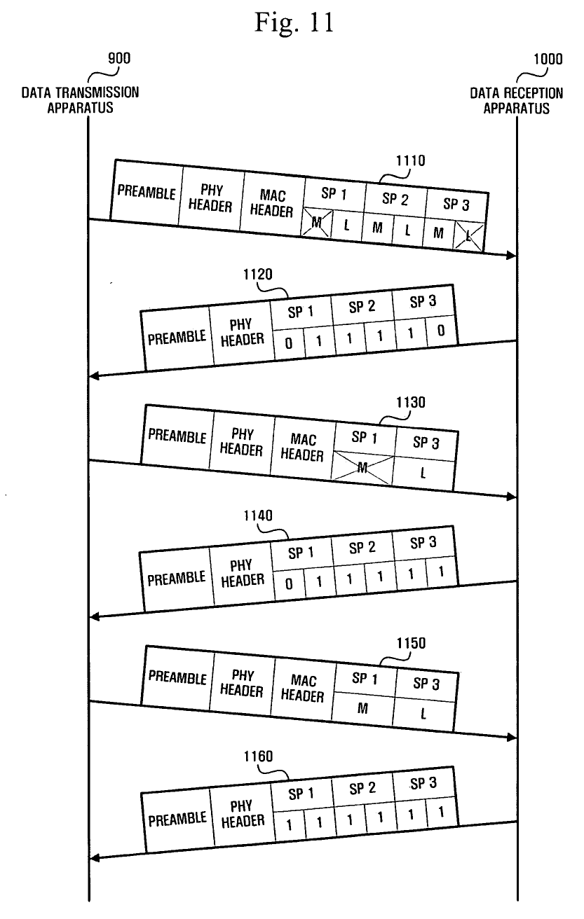

FIG. 11 illustrates a flowchart of the transmission of a data packet and a response packet between the data transmission apparatus 900 and the data reception apparatus 1000. Referring to FIG. 11, the data transmission apparatus 900 generates a data packet 1110 including sub-packets (SP) 1 through 3 and transmits the data packet 1110 to the data reception apparatus 1000. Each of sub-packets 1 through 3 may include an MSB portion and an LSB portion.

The data reception apparatus 1000 receives the data packet 1110, inspects each of sub-packets 1 through 3 the data packet 1110 for errors and recognizes that the MSB portion of sub-packet 1 and the LSB portion of sub-packet 3 are erroneous based on the results of the inspection of the data packet 1110. Then, the data reception apparatus 1000 transmits a first response packet 1120 including the results of the inspection of the data packet 1110 to the data transmission apparatus 900.

The data transmission apparatus 900 receives the first response packet 1120 and recognizes that the MSB portion of sub-packet 1 and the LSB portion of sub-packet 3 are erroneous based on the first response packet 1120. Then, the data transmission apparatus 900 generates a first retransmission packet 1130 including the MSB portion of sub-packet 1 and the LSB portion of sub-packet 3 and transmits the first retransmission packet 1130 to the data reception apparatus 1000.

The data reception apparatus 1000 receives the first retransmission packet 1130, inspects the first retransmission packet 1130 for errors, and recognizes that an MSB portion of sub-packet 1 is still erroneous based on the result of the inspection of the first retransmission packet 1130. Therefore, the data reception apparatus 1000 may transmit a second response packet 1140 including the result of the inspection of the first retransmission packet 1130 to the data transmission apparatus 900.

The data transmission apparatus 900 receives the second response packet 1140, generates a second retransmission packet 1150 including the MSB portion of sub-packet 1, and transmits the second retransmission packet 1150 to the data reception apparatus 1000. Since a payload field of the second retransmission packet 1150 is supposed to contain data in units of sub-packets, the data transmission apparatus 900 may insert the LSB portion of sub-packet 3 into the second retransmission packet 1150.

The data reception apparatus 1000 receives the second retransmission packet 1150, inspects the second retransmission packet 1150 for errors and recognizes that the retransmission packet 1150 is not erroneous based on the result of the inspection of the second retransmission packet 1150. Therefore, the data reception apparatus 1000 transmits a third response packet 1160 to the data transmission apparatus 900, indicating that none of sub-packets 1 through 3 received by the data reception apparatus 1000 are erroneous.

The first, second and third response packets 1120, 1140 and 1160 are illustrated in FIG. 11 as including not only error detection result data for erroneous sub-packet portions but also error detection result data for non-erroneous sub-packet portions. However, the present invention is not restricted to this. That is, the first, second and third response packets 1120, 1140 and 1160 may include error detection result data only for erroneous sub-packet portions.

As described above, according to the exemplary embodiments of the present invention, a sub-packet is divided into a plurality of sub-packet portions having different significance levels, and an erroneous bit or a group of erroneous bits, if any, of a sub-packet are retransmitted, thereby stabilizing the transmission of data and improving the data transmission efficiency.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation.

What is claimed is:

1. An apparatus for transmitting data, the apparatus comprising:
an error detection module which determines whether each of a plurality of portions of a transmitted packet having different significance levels is erroneous based on a received response packet;
a data-packet generation module which generates a retransmission packet including at least one erroneous portion of the transmitted packet according to a result of the determination by the error detection module; and
a communication module which transmits the retransmission packet through a communication channel.

2. The apparatus of claim 1, wherein:
the transmitted packet comprises at least one sub-packet comprising a plurality of sub-packet portions having different significance levels; and
the error detection module determines whether each of the sub-packet portions is erroneous.

3. The apparatus of claim 2, wherein the data-packet generation module inserts an erroneous sub-packet portion of the sub-packet into the retransmission packet.

4. The apparatus of claim 2, wherein the data-packet generation module inserts all of the sub-packet into the retransmission packet if the error detection module determines that at least one of the sub-packet portions of the sub-packet is erroneous.

5. The apparatus of claim 2, wherein the data-packet generation module inserts the erroneous sub-packet portion into the retransmission packet along with a null portion or a previously-detected erroneous sub-packet portion as a sub-packet of the retransmission packet.

6. The apparatus of claim 2, wherein each of the transmitted packet and the retransmission packet comprises a cyclic redundancy check code for each sub-packet portion.

7. The apparatus of claim 1, wherein the transmitted packet is a packet of uncompressed audio or video data.

8. The apparatus of claim 1, wherein the communication module transmits the transmitted packet or the retransmission packet using a channel bandwidth of 0.5 GHz to about 2.5 GHz.

9. An apparatus for receiving data, the apparatus comprising:
a packet inspection module which inspects each of a plurality of portions of a received packet having different significance levels for errors;
a packet generation module which generates a response packet including a result of the inspection by the packet inspection module; and
a communication module which transmits the response packet.

10. The apparatus of claim 9, wherein the received packet comprises at least one sub-packet comprising a plurality of sub-packet portions having different significant levels.

11. The apparatus of claim 10, wherein the packet inspection module inspects each of the sub-packet portions for errors by performing a cyclic redundancy check.

12. The apparatus of claim 10, further comprising a packet processing module which removes at least one erroneous portion of the received packet and stores other non-erroneous sub-packet portions of the received packet in a memory.

13. A method of transmitting data, the method comprising:
determining whether each of a plurality of portions of a transmitted packet having different significance levels is erroneous based on a received response packet;
generating a retransmission packet comprising at least one erroneous portion of the transmitted packet according to a result of the determining; and
transmitting the retransmission packet through a communication channel.

14. The method of claim 13, wherein:
the transmitted packet comprises at least one sub-packet comprising a plurality of sub-packet portions having different significance levels; and
the determining comprises determining whether each of the sub-packet portions is erroneous.

15. The method of claim 14, wherein the generating comprises inserting an erroneous sub-packet portion of the sub-packet into the retransmission packet.

16. The method of claim 14, wherein the generating comprises inserting all of the sub-packet into the retransmission packet if it is determined that at least one of the sub-packet portions of the sub-packet is erroneous.

17. The method of claim 14, wherein the generating comprises inserting an erroneous sub-packet portion into the retransmission packet along with a null portion or a previously-detected erroneous sub-packet portion as a sub-packet of the retransmission packet.

18. The method of claim 14, wherein each of the transmitted packet and the retransmission packet comprises a cyclic redundancy check code for each sub-packet portion.

19. The method of claim 13, wherein the transmitted packet is a packet of uncompressed audio or video data.

20. The method of claim 13, wherein the transmitting comprises transmitting the transmitted packet or the retransmission packet using a channel bandwidth of 0.5 GHz to about 2.5 GHz.

21. A method of receiving data, the method comprising:
inspecting each of a plurality of portions of a received packet having different significance levels for errors;
generating a response packet including a result of the inspecting; and
transmitting the response packet.

22. The method of claim 21, wherein the received packet comprises at least one sub-packet comprising a plurality of sub-packet portions having different significant levels.

23. The method of claim 21, wherein the inspecting comprises inspecting each of the sub-packet portions for errors by performing a cyclic redundancy check.

24. The method of claim 21, further comprising removing at least one erroneous portion of the received packet and storing other non-erroneous sub-packet portions of the received packet in a memory.
